(19) United States
(12) Patent Application Publication
(10) Pub. No.: US 2007/0200341 A1
(43) Pub. Date: Aug. 30, 2007

(54) Sewer tap with watertight lip

(75) Inventors: Germain Veronneau, St-Paul D'Abbotsford (CA); Jean-Claude Goyette, St-Athanase (CA)

Correspondence Address: ROBIC, CENTRE CDP CAPITAL, 1001, VICTORIA SQUARE - BLOC E - 8TH FLOOR, MONTREAL, QC, H2Z 2B7, CA

(73) Assignee: PLASTIQUES GYF LTEE

(21) Appl. No.: 11/415,243

(22) Filed: May 2, 2006

(30) Foreign Application Priority Data
Feb. 13, 2006 (CA) 2 536 134

(51) Int. Cl. F16L 27/00

(52) U.S. Cl. 285/139.2

(57) ABSTRACT

Disclosed is a tap for an easy leak-tight connection of a branch pipe to a main pipe through an opening in a sidewall of the main pipe. This tap has a leak-tight internal flexible lip projecting from the inner wall of its cylindrical body in the direction opposite the direction of insertion of the branch pipe into the tap. Upon insertion of the branch pipe into the tap, the internal flexible lip is bent over backwards by the branch pipe, thereby creating a tightening pressure on the branch pipe and thus ensuring a leak-tight joint.

### FIELD OF THE INVENTION

The present invention relates to a tap for the installation of a drain or pipe for use in agricultural, industrial, and even domestic sectors. More specifically, the invention relates to a tap provided with a leak-tight internal flexible lip that allows for an easy leak-tight connection of a branch pipe to a main pipe through an opening in a sidewall of the main pipe.

### BACKGROUND OF THE INVENTION

There exist several methods and means for connecting a branch pipe to a main pipe.

One of the more common methods consists of pouring cement on the joint between the branch pipe and the main pipe to create a leak-tight seal. Given that the joints are rigid and are often underground, they are subject to leaks arising from cracks and breaks caused by the movement and weight of the earth.

Another method consists of connecting a branch pipe to a main pipe with the aid of a tap attached to the main pipe. A self-fastening tap made of semi-rigid material is described in CA Patent Application No. 2,456,591. U.S. Pat. No. 5,694,972 discloses a tap with a stem having a tapered point that is used to pierce a hole in the main pipe at a desired branch-point location. However, this type of connection, generally used in irrigation systems, can severely deform the main pipe in the region at the junction of the two pipes consequently causing leakage.

Therefore, there exists a need for means of joining and connecting one pipe to another that are easy, inexpensive, leak-tight, and that once in place, hug the joint preventing the lateral displacement of the connected pipe and hence any leak or infiltration through this joint. These means must be especially reliable when buried underground. In addition, they must facilitate the work involved in the construction and repair of pipe networks, particularly in the excavation of subterranean networks.

### SUMMARY OF THE INVENTION

The object of the present invention is a tap with a leak-tight internal flexible lip that solves the problems outlined hereinabove. The invention is designed for use in the construction and/or repair of pipe networks, especially in the agricultural, industrial and domestic sectors.

The tap according to the invention, for a leak-tight connection of a branch pipe to an opening located in a side wall of a main pipe, has a hollow cylindrical body sized to fit into the opening of the main pipe. This cylindrical body has an outer wall, an inner wall, a first open end, and a second open end opposite the first open end.

The tap also has a channel provided in the inner wall of the cylindrical body along a circumference of the cylindrical body. The channel is cylindrical in form and forms a vacuum chamber around the branch pipe when the branch pipe is inserted into the tap.

Moreover, the tap has an internal flexible lip which projects from the inner wall of the cylindrical body towards the second open end of the cylindrical body before insertion of the branch pipe into the tap and projects from the inner wall of the cylindrical body over the channel towards the first open end of the cylindrical body after insertion of the branch pipe into the tap. The internal flexible lip has a thickness and form adapted to an outer diameter of the branch pipe so as to bend over backwards when the branch pipe is inserted into the tap and thus create a clamping pressure on the branch pipe.

Advantageously, the tap may be provided with fastening means for securing the cylindrical body of the tap to the main pipe.

Preferably, the tap is provided with an external flexible lip in the outer wall of the cylindrical body at the level of the first open end allowing a leak-tight seal between the tap and the main pipe, the external flexible lip having an outer diameter greater than the diameter of the first open end.

Preferably also, the tap may comprise abutment means in the inner wall of the cylindrical body at the level of the first open end for preventing the branch pipe from extending past the tap and protruding into the main pipe.

Advantageously, the tap can be in the form of a one-piece tap made of a semi-rigid elastomeric material.

The objects and advantages of the present invention will become more apparent and be better understood upon reading of the following non-restrictive description of a preferred embodiment of the invention given with reference to the accompanying drawings, which are presented only for illustrative purposes and should not be interpreted as limiting the scope of the invention.

### BRIEF DESCRIPTION OF THE DRAWINGS

FIG. 1 is a side view of the assembly of a branch pipe and tap according to a preferred embodiment of the invention, showing the position of the main pipe in a cross-section view of the tap.

FIG. 2a is a cross-section side view of the branch pipe and tap illustrated in FIG. 1, showing the internal flexible lip of the tap before insertion of the branch pipe into the tap; and

FIG. 2b is an exploded view of the internal flexible lip illustrated in FIG. 2a.

FIG. 3a is a cross-section side view of the branch pipe and the tap, illustrated in FIG. 1, upon insertion of the branch pipe into the tap, showing the bending over backwards of the internal flexible lip; and

FIG. 3b is an exploded view of the internal flexible lip illustrated in FIG. 3a.

FIG. 4a is a cross-section side view of the branch pipe completely inserted into the tap illustrating the internal flexible lip bent over backwards and exerting pressure onto the branch pipe; and

FIG. 4b is an exploded view of the internal flexible lip illustrated in FIG. 4a.

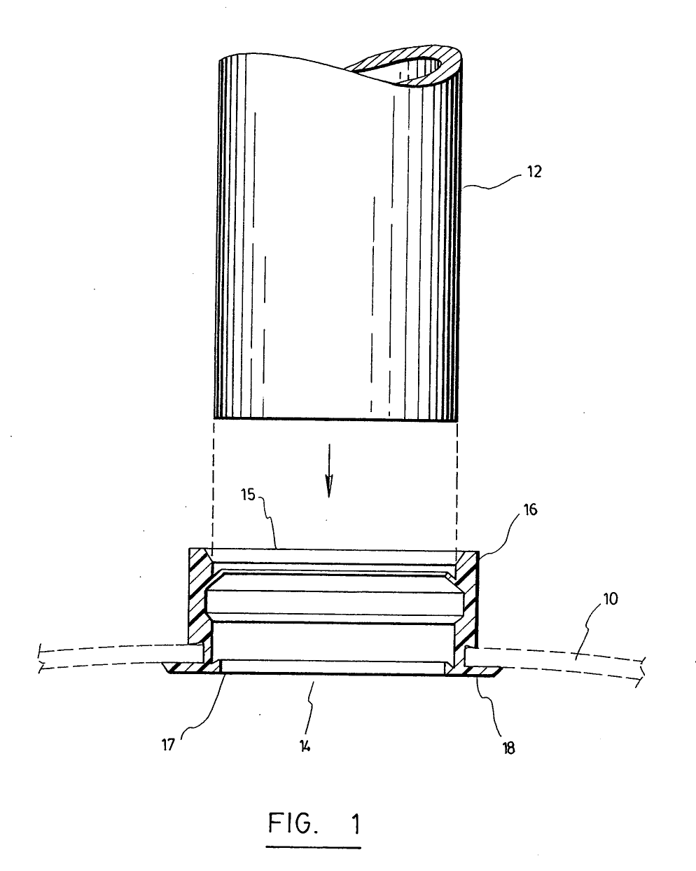

### DESCRIPTION OF A PREFERRED EMBODIMENT OF THE INVENTION

The tap (14) according to the preferred embodiment of the invention as illustrated in the accompanying drawings is intended, as all existing taps, to be used for the assembly and leak-tight connection of a branch pipe (12) to a main pipe (10) via an opening made in a side wall of the main pipe (10).

The tap (14) comprises a hollow cylindrical body (16) sized to fit into the opening of the main pipe (10). The cylindrical body (16) is provided with an outer wall (32), an inner wall (30), a first open end (17), and a second open end (15) opposite the first open end (17).

The outer wall (32) of the cylindrical body (16) has a diameter that is preferably greater than the diameter of the opening in the main pipe (10) so as to create a press fit between the tap and the main pipe.

The inner wall (30) of the cylindrical body (16) has a channel (22), cylindrical in form, which runs along a circumference of the cylindrical body. When the branch pipe (12) is inserted into the cylindrical body (16) of the tap (14), the channel (22) forms a vacuum chamber around the branch pipe (12) to prevent unwanted disconnection of the branch pipe (12) from the tap (14).

In addition, the inner wall (30) of the cylindrical body (16) has an internal flexible lip (20) of a thickness and form adapted to an outer diameter of the branch pipe (12). This internal flexible lip allows for a leak-tight joint between the cylindrical body (16) of the tap (14) and the branch pipe (12).

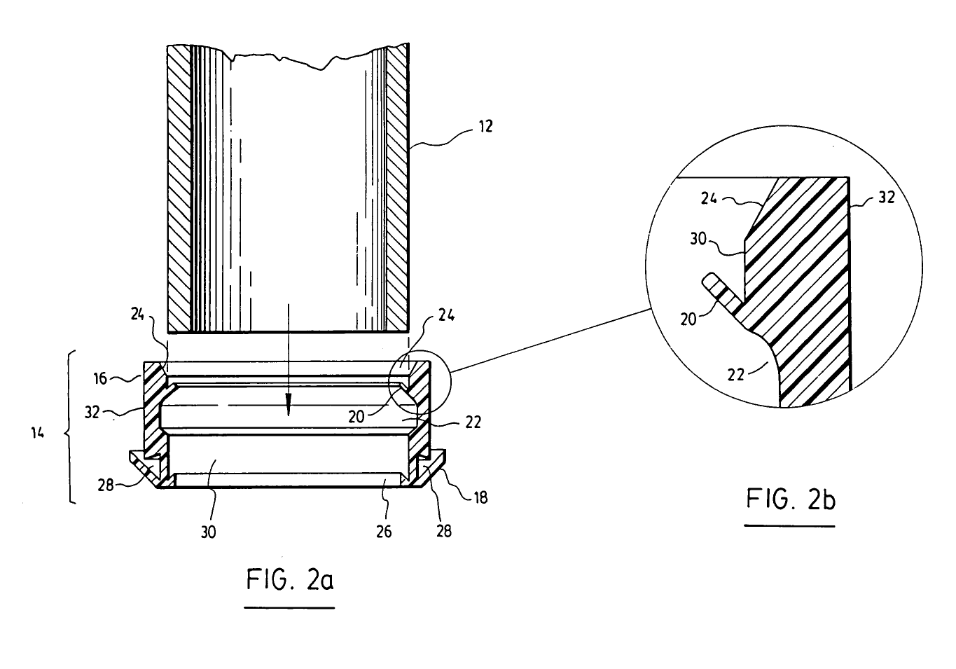

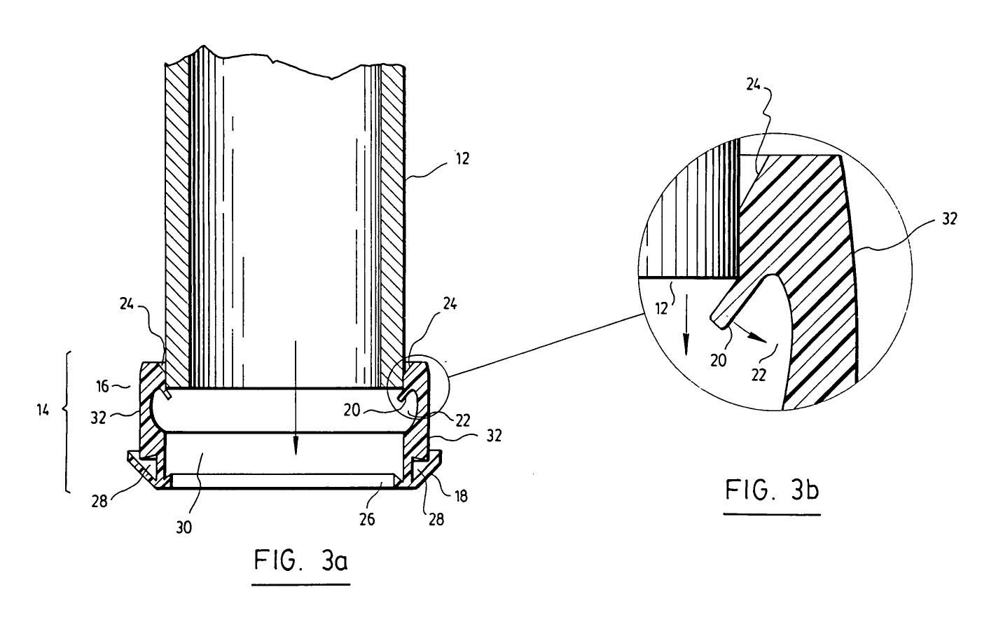

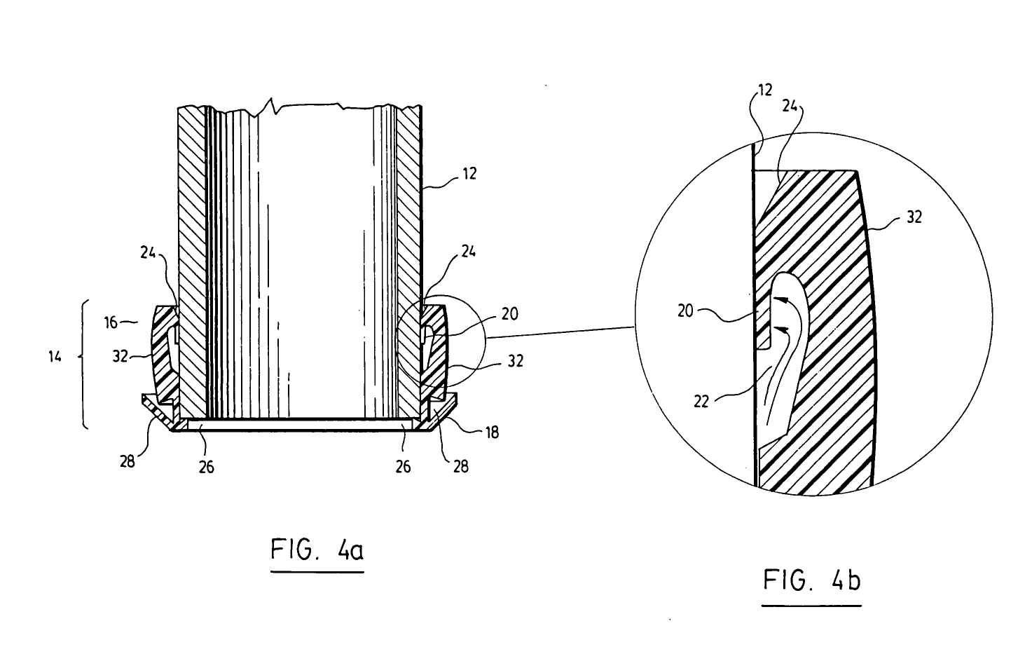

FIGS. 2, 3, and 4 depict successive steps in the insertion of the branch pipe (12) into the tap (14), showing the position and form of the internal flexible lip (20).

Before insertion of the branch pipe (12); the internal flexible lip (20) projects from the inner wall (30) of the cylindrical body (16) towards the second open end (15) of the cylindrical body, that is to say, it projects in a direction opposite to the direction of insertion of the branch pipe (12). When the branch pipe (12) is introduced into the tap (14), the lip is bent over backwards by the branch pipe (12), projecting from the inner wall of the cylindrical body over the channel (22) towards the first open end (17) of the cylindrical body (16). In this way, the restoring spring-like force exerted by the backwards-projecting internal flexible lip (20) provides a clamping pressure on the branch pipe (12). When the tap (14) is placed under water pressure, water accumulates between the lip (20) and the cylindrical body (16) of the tap (14). This accumulation of water is directly proportional to the leak-tightness of the lip (20), the greater the pressure the more leak-tight the joint between the branch pipe (12) and the lip (20). If the lip (20) was not there, the pressure that is created between the branch pipe (12) and the cylindrical body (16) of the tap (14) would expand the tap (14) and result in leakage.

According to the preferred embodiment of the invention illustrated in the drawings, the tap (14) also has an external flexible lip (18) in the wall of the cylindrical body (16) at the level the first open end (17) to ensure a leak-tight seal between the tap (14) and the main pipe (10). This external flexible lip (18) has an outer diameter greater than the diameter of the first open end and preferably a truncated-cone shape. It is in continuous contact with the surface of the inner wall (30) of the main pipe (10) by overlapping the inside edge of the opening.

In order to prevent the branch pipe (12) from being driven past the tap (14) and into the main pipe (10) when the branch pipe (12) is inserted into the tap (14), the tap (14) is advantageously provided with abutment means. In the preferred embodiment, the abutment means consist of an abutment ring (26) in the inner wall of the cylindrical body at the level of the first open end (17) whose central axis lies along the longitudinal (central) axis of the cylindrical body (16) of the tap (14) and whose inner diameter is slightly smaller than that of the cylindrical body (16) of the tap (14).

To secure the cylindrical body (16) of the tap (14) to the main pipe (10), the tap (14) may be provided with fastening means. According to the preferred embodiment illustrated in the figures, these means consist of a groove (28) in the outer wall (32) of the cylindrical body (16) that runs along a circumference of the cylindrical body, facing the external flexible lip (18) at the level the first open end (17) of the cylindrical body (16). Once the tap (14) is adjusted with some force into the pre-pierced opening of the main pipe (10), the groove (28) ensures the proper positioning and leak-tightness of the joint between the main pipe (10) and the tap (14), and prevents unwanted disconnection of the tap (14) from the main pipe (10).

Furthermore, in the preferred embodiment of the invention, the second end (15) of the tap (14) has advantageously a bevelled edge (24) to facilitate the insertion of the branch pipe (12) into the cylindrical body (16) of the tap (14).

Preferably, the tap (14), as described hereinabove and illustrated in the accompanying drawings, has the advantage of being a one-piece tap made of a semi-rigid material such as an elastomere.

Of course, modifications and changes could be made to the preferred embodiment disclosed hereinabove. As a matter of fact, all matter contained in the description given hereinabove and shown in the accompanying drawings should be interpreted as illustrative only, since changes could be made therein by one skilled in the art without departing from the scope or spirit of the claimed invention.

1. A tap for a leak-tight connection of a branch pipe to an opening located in a side wall of a main pipe, said tap comprising:
a hollow cylindrical body sized to fit into the opening of the main pipe, said cylindrical body comprising an outer wall, an inner wall, a first open end and a second open end opposite said first open end;
a channel, provided in the inner wall of the cylindrical body along a circumference of the cylindrical body, said channel being cylindrical in form and forming a vacuum chamber around the branch pipe when the branch pipe is inserted in the tap; and
an internal flexible lip which projects from the inner wall of the cylindrical body towards the second open end of the cylindrical body before insertion of the branch pipe into the tap and projects from the inner wall of the cylindrical body over the channel towards the first open end of the cylindrical body after insertion of the branch pipe into the tap, said internal flexible lip having a thickness and form adapted to an outer diameter of the branch pipe so as to bend over backwards when the branch pipe is inserted into the tap and thus create a clamping pressure on the branch pipe.

2. A tap according to claim 1, wherein the outer wall of the cylindrical body has a diameter slightly greater than the opening in the main pipe so as to create a press fit between the tap and the main pipe.

3. A tap according to claim 1, further comprising an external flexible lip in the wall of the cylindrical body at the level of the first open end to ensure a leak-tight seal between the tap and the main pipe, said external flexible lip having an outer diameter greater than the diameter of said first open end.

4. A tap according to claim 3, wherein the external lip has a truncated-cone shape.

5. A tap according to claim 1, further comprising abutment means in the inner wall of the cylindrical body at the level of the first open end of the cylindrical body for preventing the branch pipe from extending past the tap and protruding into the main pipe.

6. A tap according to claim 1, further comprising fastening means for securing the cylindrical body of the tap to the main pipe.

7. A tap according to claim 6, wherein the fastening means comprise a groove in the outer wall of the cylindrical body, said groove extending along a circumference of the cylindrical body in front of the external flexible lip at the level of the first open end of the cylindrical body.

8. A tap according to claim 1, wherein the second open end of the cylindrical body has a bevelled edge for facilitating insertion of the branch pipe into the cylindrical body of the tap.

9. A tap according to claim 1, wherein the tap is a one-piece tap made of a semi-rigid material.

10. A tap according to claim 9, wherein the semi-rigid material is an elastomeric material.

11. A tap according to claim 2, further comprising abutment means in the inner wall of the cylindrical body at the level of the first open end of the cylindrical body for preventing the branch pipe from extending past the tap and protruding into the main pipe.

12. A tap according to claim 11, further comprising fastening means for securing the cylindrical body of the tap to the main pipe.

13. A tap according to claim 12, wherein the fastening means comprise a groove in the outer wall of the cylindrical body, said groove extending along a circumference of the cylindrical body, in front of the external flexible lip at the level of the first open end of the cylindrical body.

14. A tap according to claim 12, wherein the second open end of the cylindrical body has a bevelled edge for facilitating the insertion of the branch pipe into the cylindrical body of the tap.

15. A tap according to claim 14, further comprising an external flexible lip in the wall of the cylindrical body at the level of the first open end to ensure a leak-tight joint between the tap and the main pipe, said external flexible lip having an outer diameter greater than the diameter of said first open end.

16. A tap according to claim 15, wherein the external lip has a truncated-cone shape.

17. A tap according to claim 15, wherein the tap is a one-piece tap made of a semi-rigid material.
